(19) United States
(12) Patent Application Publication
(10) Pub. No.: US 2026/0317208 A1
(43) Pub. Date: Oct. 15, 2026

(54) Electrochemical Destruction of PFAS and Organic Carbon Mixtures

(71) Applicant: Gradiant Corporation, Woburn, MA (US)

(72) Inventors: Yang Chen, Singapore (SG); Hui Han, Singapore (SG)

(21) Appl. No.: 19/485,922

(22) PCT Filed: Feb. 12, 2025
(86) PCT No.: PCT/US2025/015454

§ 371 Date: Nov. 19, 2025

Related U.S. Application Data
(60) Provisional application No. 63/553,189, filed on Feb. 14, 2024.

(51) Int. Cl. C02F 1/465; C02F 1/36; C02F 1/461; C02F 1/467; C02F 1/66; C02F 101/36

(52) U.S. Cl. CPC C02F 1/465; C02F 1/36; C02F 1/46109; C02F 1/4672; C02F 1/66; C02F 2001/46133; C02F 2101/36; C02F 2201/46105; C02F 2209/06; C02F 2303/12; C02F 2305/026

(57) ABSTRACT

An electrochemical destruction system comprises an electrochemical reactor that defines a contained volume. The electrochemical reactor includes at least one anode and at least one cathode in or extending into the contained volume of the electrochemical reactor. The at least one anode and the at least one cathode are configured to break down per- and polyfluoroalkyl substances (PFAS) in wastewater in the contained volume via electro-oxidation reactions. A pH adjustment device contains an acid and/or a base and is configured to inject the acid or base into the contained volume of the electrochemical reactor or into a volume in fluid communication with the electrochemical reactor to facilitate controlling the pH of the wastewater. A defoamer in the contained volume of the electrochemical reactor or in a volume in fluid communication with the electrochemical reactor is configured to defoam foam generated in the wastewater from the electro-oxidation reactions.

### BACKGROUND

The discussion of the background state of the art below may reflect hindsight gained from the disclosed invention(s), and these characterizations are not necessarily admitted to be prior art.

Per- and polyfluoroalkyl substances (collectively referred to as PFAS) have garnered extensive attention due to their widespread use, environmental persistence, and potential health risks, even at extremely low concentrations. The US Environmental Protection Agency (USEPA) recommends interim Health Advisory (iHA) levels for perfluorooctanoic acid (PFOA) and perfluorooctyl sulfonate (PFOS) concentrations not exceeding 4 parts per quadrillion (ppq) and 20 ppq, respectively, for both short-term and chronic risk assessment scenarios. Addressing the urgent challenge of removing and disposing of these persistent compounds from water is critical to ensure safe drinking water.

PFAS chemicals have been used in a wide variety of industrial processes due, in particular, to their resistance to heat, water, and oil, and their non-stick and stain-resistant properties. Exemplary applications in which PFAS chemicals have been used include textile and leather treatments, non-stick and heat-resistant coatings, firefighting foams, electronics (e.g., semiconductor) manufacturing, metal plating and etching, food packaging, personal care and consumer products, and industrial surfactants and lubricants.

Over the past decade, extensive research has focused on PFAS removal. However, the direct destruction of PFAS in water remains economically challenging due to their chemical persistence. Conventional biological treatment and advanced oxidation processes (AOPs), such as UV/H₂O₂ and Fenton reactions, are ineffective at breaking the strong carbon-fluorine (C-F) bonds. Successful mineralization of PFAS has been achieved through emerging technologies like plasma and electro-oxidation (EO). Among these, electro-oxidation using boron-doped diamond anodes (BDD) has been widely studied at laboratory scales. Despite its efficacy, the high material and manufacturing costs of BDD, involving expensive substrates (e.g., niobium) and high-temperature chemical vapor deposition (CVD), limit its industrial feasibility. Nevertheless, studies indicate that PFAS destruction on BDD surfaces follows first-order reaction kinetics at low concentrations (see Example 1, infra). Integrating BDD EO with PFAS concentration technologies, which increase PFAS levels by orders of magnitude, could significantly lower electrode costs and make PFAS destruction using BDD electrodes commercially viable.

Several concentration techniques, such as membrane separation [e.g., reverse osmosis (RO) and nanofiltration (NF)] and foam fractionation, have been reported to separate PFAS from water. However, these methods face challenges in efficiently removing both short-chain PFAS (e.g., PFBA, PFBS) and long-chain PFAS (e.g., PFOA, PFOS) to below critical discharge limits. To address these challenges, additional chemicals—often surfactants, such as cetyltrimethylammonium bromide (CTAB) or octyltrimethylammonium bromide (OTAB)—are used to facilitate PFAS separation. These surfactants work through electrostatic and hydrophobic interactions, forming micelles that complex with PFAS molecules. This synergistic mechanism enhances the efficiency of PFAS separation from influent water into concentrate streams, such as “foamate” in foam fractionation systems or “reject/brine” in RO/NF systems.

Ultimately, PFAS destruction is often accompanied by the treatment of large amounts of organic carbon, which is complexed with PFAS at a high total organic carbon (TOC) to PFAS ratio. The presence of high TOC levels in water can hinder PFAS destruction (see Example 2, infra). Direct EO treatment of high TOC-to-PFAS water often results in incomplete mineralization of both PFAS and TOC. Furthermore, the discharge of large amounts of surfactants into the environment poses additional environmental risks.

### SUMMARY

An electrochemical destruction system and a method for the electrochemical destruction of per- and polyfluoroalkyl substances (collectively referred to as PFAS) are described herein, where various implementations of the system and methods may include some or all of the elements, features, and steps described below.

An electrochemical destruction system comprises an electrochemical reactor that defines a contained volume. The electrochemical reactor includes at least one anode and at least one cathode in or extending into the contained volume of the electrochemical reactor. The at least one anode and the at least one cathode are configured to break down per- and polyfluoroalkyl substances (PFAS) in wastewater in the contained volume via electro-oxidation reactions. A pH adjustment device contains an acid and/or a base and is configured to inject the acid or base into the contained volume of the electrochemical reactor or into a volume in fluid communication with the electrochemical reactor to facilitate controlling the pH of the wastewater. A defoamer in the contained volume of the electrochemical reactor or in a volume in fluid communication with the electrochemical reactor is configured to defoam foam generated in the wastewater from the electro-oxidation reactions.

A method for electrochemically destroying PFAS, which can use the above-described system, includes providing an electrochemical reactor containing a bath of wastewater that contains PFAS, wherein the electrochemical reactor includes at least one anode and at least one cathode immersed in the bath of wastewater. An acid or a base is added to the wastewater to maintain a reaction pH in the electrochemical reactor at a targeted pH below 4.3. In the electrochemical reactor, an applied current and voltage is delivered to the immersed anode and cathode to electrochemically destroy at least some of the PFAS in the wastewater; and foam produced in the electrochemical reactor is subject to defoaming.

The wastewater can further include additional organic carbon compounds, such as organic carbon compounds produced in an earlier industrial process and organic carbon compounds introduced into the wastewater in an upstream wastewater treatment process. The method can further include adding hydrogen peroxide (H₂O₂) and at least one of ferrous ions (Fe²⁺) or ferric ions (Fe³⁺) to the wastewater and reducing the organic carbon compounds via a Fenton or electro-Fenton reaction utilizing hydroxyl radicals generated by the added hydrogen peroxide and the added Fe²⁺ and/or Fe³⁺ ions.

This invention introduces an efficient electrochemical method to efficiently destroy PFAS in the presence of high concentrations of organic carbon, particularly surfactants. Whether the TOC originates from natural sources, industrial processes, or is intentionally added, this method can achieve over 99% reduction of both TOC and PFAS.

### BRIEF DESCRIPTION OF THE DRAWINGS

FIG. 1 is a schematic illustration of an electrochemical destruction system, including a storage tank and an electrochemical reactor, showing the PFAS destruction methodology.

FIG. 2 is a plot of the removal rate of total organic carbon (TOC) 30 and perfluorooctanoic acid (PFOA) 32 as a function of treatment time during the treatment of 50 parts per million (ppm) PFOA in the aqueous feed liquid.

FIG. 3 is a plot of the log removal performance of TOC 30 and PFOA 32 during the treatment of the aqueous feed liquid with the 50 ppm PFOA.

FIG. 4 is a plot of the degradation performance of the CTAB and PFOA mixture on the BDD anode, wherein no pH adjustment was performed.

FIG. 5 is a plot of the degradation performance of the CTAB and PFOA mixture on the BDD anode with pH control for TOC 30 and total PFAS 34.

FIG. 6 is a plot of the log removal performance of total PFAS.

FIG. 7 includes plots of the treatment of CTAB and PFOA with 36 or without 38 introducing e-Fenton reactions (i.e., using boron-doped diamond anode alone 38 or with the addition of e-Fenton reactions 36).

In the accompanying drawings, like reference characters refer to the same or similar parts throughout the different views. The drawings are not necessarily to scale; instead, an emphasis is placed on illustrating particular principles in the exemplifications discussed below. For any drawings that include text (words, reference characters, and/or numbers), alternative versions of the drawings without the text are to be understood as being part of this disclosure; and formal replacement drawings without such text may be substituted therefor.

### DETAILED DESCRIPTION

The foregoing and other features and advantages of various aspects of the invention(s) will be apparent from the following more particular description of various concepts and specific implementations within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used, or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances. Percentages or concentrations expressed herein can be in terms of weight or volume. Processes, procedures, and phenomena described below can occur at ambient pressure (e.g., about 50-120 kPa—for example, about 90-110 kPa) and temperature (e.g., −20 to 50° C.—for example, about 10-35° C.) unless otherwise specified.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary implementations.

Spatially relative terms, such as “above,” “below,” “left,” “right,” “in front,” and “behind,” may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term “above” may encompass both an orientation of above and below. The apparatus may be otherwise oriented (e.g., rotated 90 degrees or at other orientations), and the spatially relative descriptors used herein should be interpreted accordingly. The term “about” can mean within ±10% of the value recited. In addition, where a range of values is provided, each subrange and each individual value between the upper and lower ends of the range is contemplated and, therefore, disclosed.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

Some of the terminology used herein is associated with particular implementations and is not intended to limit more generic exemplifications of the invention. As used herein, singular forms, such as those introduced with the articles, “a” and “an,” are intended to include the plural forms as well, unless the context indicates otherwise. Additionally, the terms “includes,” “including,” “comprises,” and “comprising” specify the presence of the stated elements or steps but do not preclude the presence or addition of one or more other elements or steps.

Additionally, the various components identified herein can be provided in an assembled and finished form; or some or all of the components can be packaged together and marketed as a kit with instructions (e.g., in written, video, or audio form) for assembly and/or modification by a customer to produce a finished product.

A flow diagram from an electrochemical destruction system and method is illustrated in FIG. 1. Equipment in this system includes an electrochemical reactor 10 connected with a storage tank 12 by liquid circulation lines 14 and 16. In alternative embodiments, the electrochemical reactor 10 and the storage tank 12 can be combined, such that all of the components of the storage tank 12 discussed below are instead incorporated into the electrochemical reactor 10, and wherein the wastewater bath 28 can remain in the electrochemical reactor 10 rather than be circulated back and forth between the two components.

The storage tank 12 defines a contained volume containing a bath of wastewater 28 that contains per- and polyfluoroalkyl substances (PFAS). Coupled with storage tank 12 and in fluid communication with the bath of wastewater 28 is a pH adjustment device 18, a chemical dosing system 20, and a defoamer 22.

The pH adjustment device 18 can include a dosing pump connected to an acid tank (containing, e.g., hydrochloric acid or sulfuric acid) and/or a base tank (containing, e.g. sodium hydroxide) to control the reaction pH. To achieve ≥99% destruction of PFAS and total organic carbon (TOC), the pH adjustment device 18 maintains the pH of the bath of the aqueous feed liquid (and, by extension, the aqueous feed liquid in the electrochemical reactor 10) below 4.3 throughout the process.

The chemical dosing system 20 introduces hydrogen peroxide (H₂O₂), and at least one of ferrous ions (Fe²⁺) or ferric ions (Fe³⁺) into the storage tank as needed for the electro-Fenton (e-Fenton) reaction, facilitating the production of hydroxyl radicals (·OH).

The defoamer 22 can be in the form of a mechanical defoamer and can be utilized to manage the foam generated during the electro-oxidation (EO) process in the electrochemical reactor 10, as EO typically produces a large number of bubbles on the electrodes 24 and 26; and those bubbles will tend to fractionate PFAS from water, similar to as is found in foam fractionation processes. The defoamer 22 breaks down the foam, allowing PFAS to re-dissolve into the reactor water, which enhances the overall reaction efficiency. The defoamer 22 can be a mechanical defoamer (including an impeller that rotates to break up the foam via a shearing force as the impeller passes through the bubbles) or an ultrasonicator (that generates a high-frequency agitation to the liquid and the foam to disrupt the bubble structure of the foam). Alternatively, an external defoamer can be employed [e.g., an overflow weir can be used to remove the foam (as the overflow) from the electrochemical reactor 10 or from the storage tank 12 so that the foam can be broken down in a separate vessel].

The electrochemical reactor 10 includes at least one anode 24 that can be formed of boron-doped diamond (BDD) or a titanium suboxide, and at least one cathode 26 can be made of titanium, stainless steel, mixed metal oxides or platinum (also known as dimensionally stable anodes), BDD, or graphite. The anode(s) 24 and the cathode(s) 26 are both connected with a voltage source to generate a voltage differential therebetween. PFAS and organic carbon destruction occurs directly on the anode surface. Indirect oxidation can be introduced through the e-Fenton process, which facilitates the destruction of PFAS-complexed organic compounds. In this combined process, hydrogen peroxide (H₂O₂) and iron ions are dosed to generate hydroxyl radicals (·OH). The regeneration of ferrous ions (Fe²⁺) from ferric ions (Fe³⁺) occurs on the cathode surface, ensuring a continuous supply of Fe²⁺ for the e-Fenton reactions. Organic carbon compounds other than PFAS (e.g., organic compounds in the wastewater as originally produced in, e.g., an industrial process and/or organic compounds that are introduced upstream of the electrochemical reactor 10 and storage tank 12 to process the wastewater) can be reduced via these methods.

Major chemical reactions of the electrochemical destruction of PFAS and other forms of dissolved organic carbon (DOC), include the following, wherein the up arrow indicates volatilized products:

PFAS+Anode→H₂O+CO₂↑+F⁻ (1)

Anode+H₂O→·OH (2)

DOC+Anode→H₂O+CO₂↑ (3)

DOC+·OH→H₂O+CO₂↑ (4)

Major chemical reactions associated with Fenton/e-Fenton processes where targeted with the addition of iron ions and hydrogen peroxide include the following, in addition to reactions (1) to (4), above:

Fe³⁺+e⁻→Fe²⁺ (5)

Fe²⁺+H₂O₂→Fe³⁺+·OH+OH⁻ (6)

The treatment of the wastewater typically operates as a batch process. The pH of the wastewater is adjusted and maintained at a pH value below 4.3 before and during the electrochemical oxidation. A pH higher than this value can result in inefficient total organic carbon (TOC) or PFAS reduction.

Upstream from the electrochemical reactor 10 and, if present, storage tank 12, PFAS can be concentrated in the wastewater using, e.g., a nanofiltration system, a reverse-osmosis system, an ultrafiltration system, a foam fractionation system, an ion-exchange system, or a granular-activated-carbon absorption system.

In a foam fractionation process developed by the applicant for concentrating and removing PFAS from aqueous solutions uses a system that includes a vessel designed to process a liquid solution containing PFAS molecules and a surfactant [e.g., a cationic surfactant, such as cetyltrimethylammonium bromide (CTAB) or trimethyloctylammonium bromide (OTAB)]. A bubbler injects fine bubbles (with a size ranging from, e.g., 1 to 200 microns) into the solution, creating an interface where PFAS molecules can associate with the bubbles. These PFAS-associated bubbles rise to the surface, forming a foamate that contains concentrated PFAS, while the remaining liquid, with a significantly lower PFAS concentration, exits the system as liquid output.

The system also features an elongated portion in the vessel, designed to optimize the separation of the PFAS molecules by allowing sufficient residence time for the bubbles to interact with the PFAS. The foamate is collected at the distal end of the elongated portion, and the system can also involve multiple stages of foam fractionation to further concentrate the PFAS. This multi-stage process can involve recycling the liquid and/or foamate outputs, thereby increasing the concentration factor of the PFAS molecules.

In the treatment method, the input solution undergoes bubble exposure, resulting in PFAS molecules associating with the bubbles, which are then separated into a foamate. The foamate may have a significantly higher PFAS concentration, potentially by a factor of 50 or more compared to the original solution. This concentrated foamate can then be processed as the wastewater used in the above-described systems and methods.

### EXAMPLES

### Example 1: First-Order Reaction of PFAS Destruction on BDD Surface

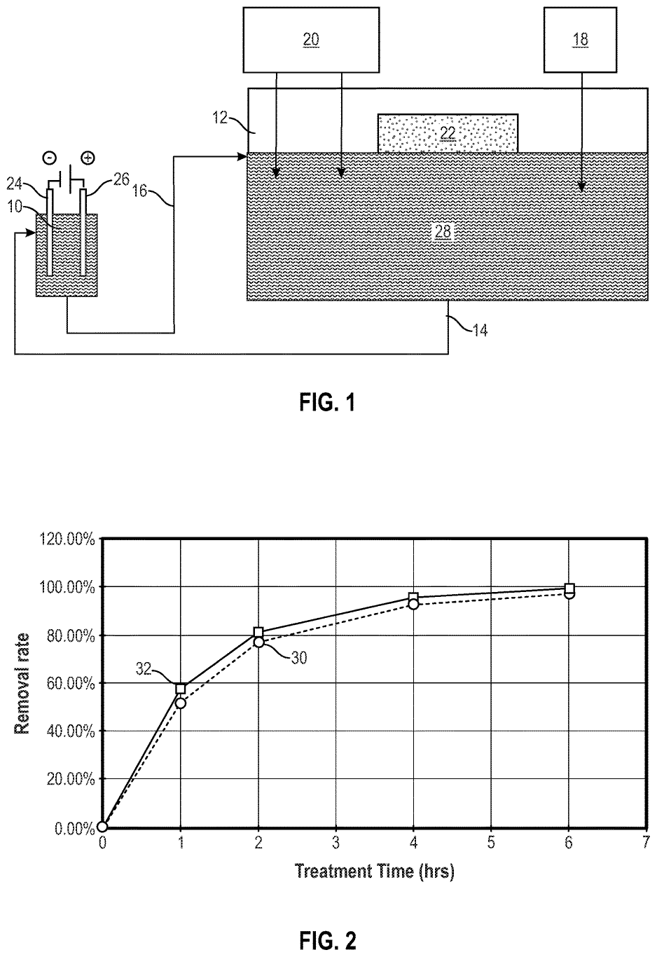

The results of a batch process designed to treat 50 ppm perfluorooctanoic acid (PFOA) in synthetic wastewater using an electro-oxidation reactor with a boron-doped-diamond (BDD) anode are shown in FIG. 2. Each batch treated 30 liters of wastewater, with periodic monitoring of total organic carbon (TOC) 30 and PFOA 32 concentrations.

The results demonstrate the exceptional mineralization capability of BDD electrodes. By the end of the batch process, substantial reductions in both TOC 30 and PFOA 32 concentrations were observed, highlighting the effectiveness of the BDD electro-oxidation reactor in achieving significant PFAS destruction.

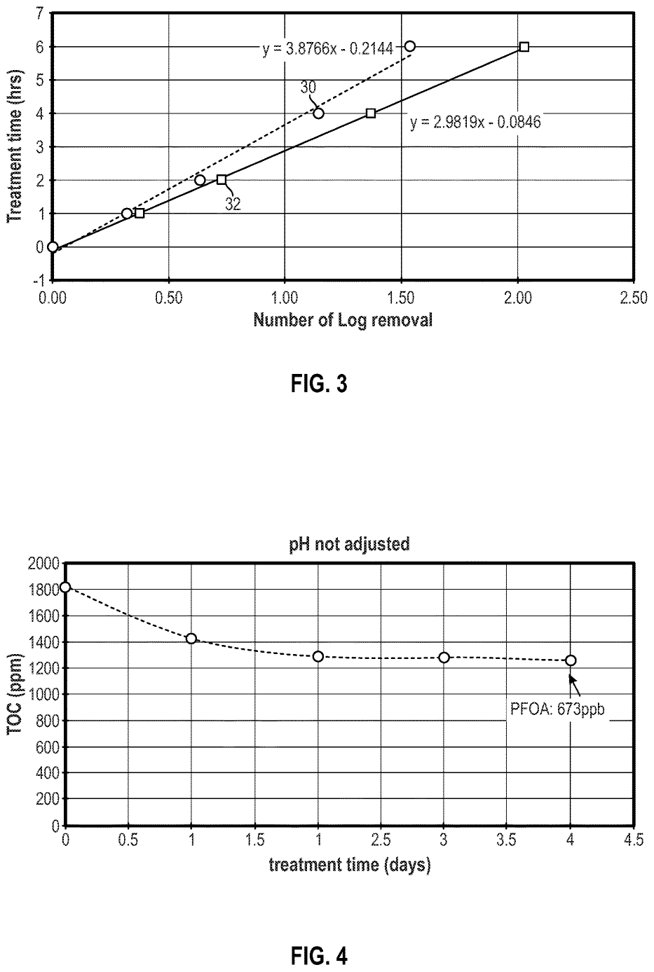

Detailed analysis of FIG. 2 reveals the log removal trends illustrated in FIG. 3. These trends confirm that PFOA destruction follows first-order reaction kinetics when PFAS concentrations are below 50 parts per million (ppm). This behavior underscores the efficiency and predictability of the BDD electro-oxidation process in treating low-concentration PFAS-contaminated water.

### Example 2: Destruction of PFAS in High-Concentration CTAB Water by pH Adjustment

A synthetic wastewater mixture was prepared by spiking 3,000 ppm cetyltrimethylammonium bromide (CTAB) and 1 ppm PFOA for electro-oxidation treatment using a beach-top setup. For each test, 2.5 liters of the wastewater was treated with a 200 cm² BDD anode, applying a direct current of 1.2 A in the electrochemical cell. Performance was monitored by tracking total organic carbon (TOC) for CTAB degradation and PFOA concentrations. PFAS analysis was performed using liquid chromatography-tandem mass spectrometry (LC-MS/MS) with solid-phase extraction (SPE).

At the start of the test, the pH of the wastewater was 6, and no pH adjustments were made throughout the experiment. The results, shown in FIG. 4, indicate that without pH adjustment, the destruction of CTAB stagnates after a certain point, with a maximum removal of approximately 28% based on TOC calculations. Despite this, a significant amount of surfactant remains in the wastewater, continuing to complex with PFAS. Consequently, PFOA destruction is also limited. By the end of the treatment, a large residual amount of 673 parts per billion (ppb) PFOA remained untreated.

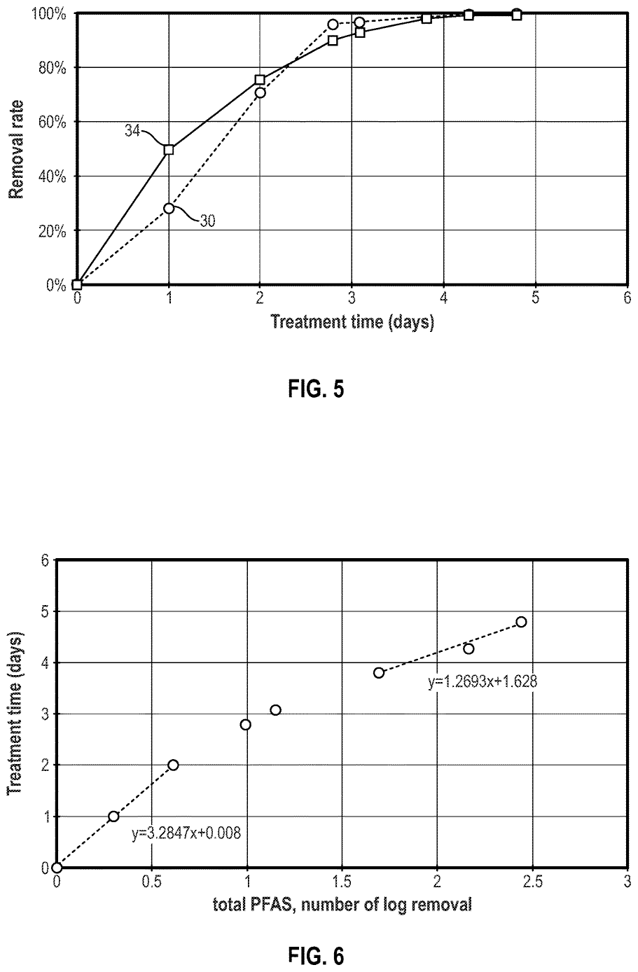

In contrast, the same test was conducted with the pH monitored and maintained below 4.3 throughout the experiment by introducing concentrated H₂SO₄. The results with the removal rates for TOC 30 and PFAS 34 are shown in FIG. 5. Under these conditions, CTAB and its degradation by-products were continuously degraded, as indicated by the TOC results 30. At the end of the treatment, the process achieved a TOC removal rate of 99.84%.

Additionally, PFOA and all its measurable by-products (typically shorter-chain PFAS, referred to as total PFAS) were also continuously decomposed, achieving a 99.64% removal rate. It is worth noting that extending the treatment time in the BDD reactor can further reduce CTAB and PFAS concentrations, if necessary.

The plot of FIG. 6 reflects data further processed from the data shown in FIG. 5, wherein more information regarding reaction kinetics is extracted. In contrast to the first-order reaction kinetics observed when treating only PFOA, as shown in FIG. 3, the destruction kinetics in the presence of CTAB are closely intertwined. The retention time required to achieve one log of PFAS removal at low CTAB concentrations is only 38.6% of the time needed at high CTAB concentrations. This significant difference highlights the substantial impact that CTAB has on PFAS destruction efficiency.

### Example 3: PFAS Destruction in Real Semiconductor Wastewater Containing TMAH

A real wastewater sample from an industrial source was collected and tested in our lab. The water was pretreated using foam fractionation, and the foamate was collected for electro-oxidation (EO) treatment in the electrochemical reactor with the BDD anode. Analysis revealed that the foamate predominantly contained tetramethylammonium hydroxide (TMAH) with a total organic carbon (TOC) concentration of approximately 350 ppm.

For each test, 0.8 liters of wastewater was treated using a 200 cm² BDD anode, applying a direct current of 0.8 A in the electrochemical cell. PFAS analysis was performed using liquid chromatography-tandem mass spectrometry (LC-MS/MS). The pH of the wastewater throughout the treatment was maintained below 4.3.

At the end of the treatment, the TOC concentration was found to be less than 2 ppm. Table 1 below presents the recorded concentrations (in ppt) of various PFAS species during the treatment process.

TABLE 1

| Treatment | PFBA | PFBS | PFOA | PFOS | PFHxS | PFNA | TOC |
|---|---|---|---|---|---|---|---|
| time (days) | (ppt) | (ppt) | (ppt) | (ppt) | (ppt) | (ppt) | (ppm) |
| 0 | 6,410 | 22,800 | 2,790 | 13,200 | 1,680 | 581 | 350 |
| 1 | 20 | 973 | 72.6 | 235 | 211 | 82.2 | — |
| 3 | 14.6 | 130 | 15.5 | 24.6 | 10.5 | 10.1 | — |
| 5 | 1.29 | 1.73 | 1.03 | 1.66 | 2.53 | U.D | 1.38 |

Note that “U.D.” stands for under the detection limit.

### Example 4: Pilot Test for Foamate Destruction (PFAS and CTAB)

A PFAS-enriched foamate was collected from an upstream foam fractionation process that was assisted by CTAB for PFAS separation. A total of 20 liters of the foamate was fed into the electrochemical reactor with the BDD anode (with a BDD surface area of approximately 1 m²) for foam and PFAS destruction. A current of 126 A/m² was applied to the BDD electrode, and each batch treatment was operated for 24 hours. Throughout the entire treatment process, the pH was maintained below 4.3.

Results of this treatment process are presented in Table 2, below.

TABLE 2

| Treatment | PFBA | PFBS | PFOA | PFOS | TOC |
|---|---|---|---|---|---|
| time (hrs) | (ppb) | (ppb) | (ppb) | (ppb) | (ppm) |
| 0 | 1,020 | 1,034 | 1,012 | 1,008 | 642 |
| 24 | 8.76 | 4.41 | 3.54 | 1.28 | 3.55 |

### Example 5: PFAS Destruction with Assistance from e-Fenton

Following a similar experimental approach to that of Example 2, synthetic wastewater was prepared by spiking 3,000 ppm CTAB and 1 ppm PFOA for electro-oxidation treatment using the bench-top setup, assisted by e-Fenton reactions. 3,000 ppm of ferric ions [in the form of Fe₂(SO₄)₃] was mixed with 2.5 liters of the spiked solution, and the pH was maintained between 1.5 and 2.

A current of 2 amperes (A) was applied to the 200-cm² BDD anode, with a titanium plate used as the cathode. During the operation, a 30-weight-% hydrogen peroxide (H₂O₂) solution in water was introduced into the reaction container at a rate of 112 mmol/hr to initiate the Fenton reactions.

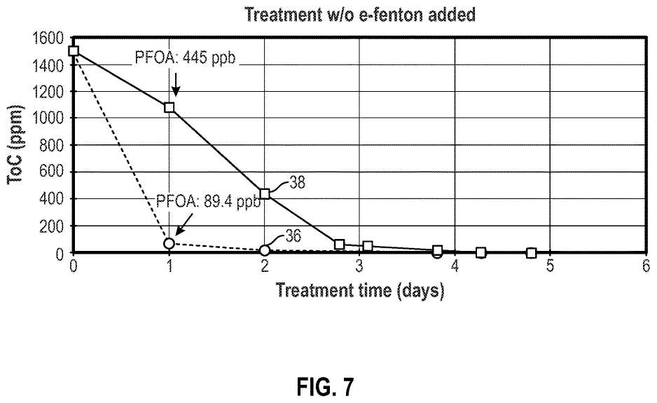

The results, shown in FIG. 7, demonstrate a significant enhancement in the destruction of both CTAB and PFOA when direct BDD electro-oxidation (EO) is combined with e-Fenton reactions 38 in comparison with the use of BDD electro-oxidation alone 36.

In describing implementations herein, specific terminology is used for the sake of clarity. For the purpose of description, specific terms are intended to at least include technical and functional equivalents that operate in a similar manner to accomplish a similar result. Additionally, in some instances where a particular implementation includes a plurality of system elements or method steps, those elements or steps may be replaced with a single element or step. Likewise, a single element or step may be replaced with a plurality of elements or steps that serve the same purpose. Further, where parameters for various properties or other values are specified herein for implementations, those parameters or values can be adjusted up or down by 1/100^{th}, 1/50^{th}, 1/20^{th}, 1/10^{th}, ⅕^{th}, ⅓^{rd}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof or within a range of the specified parameter up to or down to any of the variations specified above (e.g., for a specified parameter of 100 and a variation of 1/100^{th}, the value of the parameter may be in a range from 0.99 to 1.01), unless otherwise specified. Further still, where methods are recited and where steps/stages are recited in a particular order—with or without sequenced prefacing characters added for ease of reference—the steps/stages are not to be interpreted as being temporally limited to the order in which they are recited unless otherwise specified or implied by the terms and phrasing.

Additional examples consistent with the present teachings are set out in the following numbered clauses:

1. An electrochemical destruction system, comprising:
an electrochemical reactor that defines a contained volume, wherein the electrochemical reactor includes at least one anode and at least one cathode in or extending into the contained volume of the electrochemical reactor, wherein the at least one anode and the at least one cathode are configured to break down per- and polyfluoroalkyl substances (PFAS) in wastewater in the contained volume via electro-oxidation reactions;
a pH adjustment device containing at least one of an acid or a base and configured to inject the acid or base into the contained volume of the electrochemical reactor or into a volume in fluid communication with the electrochemical reactor to facilitate controlling the pH of the wastewater; and
a defoamer in the contained volume of the electrochemical reactor or in a volume in fluid communication with the electrochemical reactor and configured to defoam foam generated in the wastewater from the electro-oxidation reactions.

2. The electrochemical destruction system of clause 1, further comprising a chemical dosing system containing (a) hydrogen peroxide (H₂O₂) and at least one of (b) ferrous ions (Fe²⁺) or ferric ions (Fe³⁺), wherein the chemical dosing system is configured to inject these compositions into the contained volume of the electrochemical reactor or into a volume in fluid communication with the electrochemical reactor.

3. The electrochemical destruction system of clause 1 or 2, further comprising a voltage source in electrical communication with the at least one anode and with the at least one cathode.

4. The electrochemical destruction system of any of clauses 1-3, further comprising:
a storage tank that contains the wastewater;
a first conduit coupling the storage tank with the electrochemical reactor and configured to transfer the wastewater from the storage tank to the electrochemical reactor; and
a second conduit coupling the storage tank with the electrochemical reactor and configured to transfer the wastewater from the electrochemical reactor back to the storage tank.

5. The electrochemical destruction system of clause 4, wherein the pH adjustment device is configured to inject the acid or base into the storage tank.

6. The electrochemical destruction system of clause 4 or 5, wherein the defoamer is in the storage tank.

7. The electrochemical destruction system of any of clauses 1-6, wherein the anode comprises boron-doped diamond.

8. The electrochemical destruction system of any of clauses 1-7, wherein the anode comprises titanium suboxides.

9. The electrochemical destruction system of any of clauses 1-8, wherein the cathode comprises at least one of titanium, stainless steel, mixed metal oxides or platinum, boron-doped diamond, or graphite.

10. The electrochemical destruction system of any of clauses 1-9, wherein the defoamer is selected from a mechanical defoamer and an ultrasonicator.

11. The electrochemical destruction system of any of clauses 1-10, further comprising a bath of the wastewater contained in the electrochemical reactor.

12. The electrochemical destruction system of clause 11, further comprising a foam layer formed of a liquid film surrounding gas bubbles atop the bath of the wastewater, wherein the liquid film of the foam layer contains a higher concentration of PFAS than does the bath of the wastewater.

13. The electrochemical destruction system of any of clauses 1-12, further comprising a PFAS concentration system in fluid communication with the contained volume of the electrochemical reactor.

14. The electrochemical destruction system of clause 13, wherein the PFAS concentration system comprises at least one of a nanofiltration system, a reverse-osmosis system, an ultrafiltration system, a foam fractionation system, an ion-exchange system, or a granular-activated-carbon adsorption system.

15. The electrochemical destruction system of any of clause 1-13, wherein the wastewater includes a blend of PFAS and other organic chemicals.

16. A method for electrochemically destroying per- and polyfluoroalkyl substances (PFAS), comprising:
providing an electrochemical reactor containing a bath of wastewater that contains PFAS, wherein the electrochemical reactor includes at least one anode and at least one cathode immersed in the bath of wastewater;
adding an acid or a base to the wastewater to maintain a reaction pH in the electrochemical reactor at a targeted pH below 4.3;
in the electrochemical reactor, delivering an applied current and voltage to the immersed anode and cathode to electrochemically destroy at least some of the PFAS in the wastewater; and
defoaming foam produced in the electrochemical reactor.

17. The method of clause 16, wherein the wastewater further comprises additional organic carbon compounds.

18. The method of clause 17, wherein the additional organic carbon compounds include organic carbon compounds produced in an earlier industrial process and organic carbon compounds introduced into the wastewater in an upstream wastewater treatment process.

19. The method of clause 17 or 18, wherein at least 99% of the PFAS and the additional organic carbon compounds in the wastewater is destroyed in the electrochemical reactor.

20. The method of clause 17, further comprising:
adding hydrogen peroxide (H₂O₂) and at least one of ferrous ions (Fe²⁺) or ferric ions (Fe³⁺) to the wastewater; and
reducing the additional organic carbon compounds via a Fenton or electro-Fenton reaction utilizing hydroxyl radicals generated by the added hydrogen peroxide and the added Fe²⁺ and/or Fe³⁺ ions.

21. The method of any of clauses 16-20, wherein the anode comprises boron-doped diamond or a titanium suboxide.

22. The method of any of clauses 16-21, wherein the cathode comprises at least one of titanium, stainless steel, mixed metal oxides, and platinum, boron-doped diamond, or graphite.

23. The method of any of clauses 16-22, wherein the foam comprises a liquid film surrounding gas bubbles atop the bath of the wastewater, wherein the liquid film of the foam contains a higher concentration of PFAS than does the bath of the wastewater.

24. The method of any of clauses 16-23, further comprising concentrating PFAS in the wastewater from an upstream source and then delivering the wastewater with the concentrated PFAS concentration to the electrochemical reactor.

25. The method of clause 24, wherein the PFAS is concentrated via a concentration system selected from at least one of nanofiltration, reverse osmosis, ultrafiltration, foam fractionation, ion exchange, or granular-activated-carbon adsorption.

While this invention has been shown and described with references to particular implementations thereof, those skilled in the art will understand that various substitutions and alterations in form and details may be made therein without departing from the scope of the invention. Further, other aspects, functions, and advantages are also within the scope of the invention, and all implementations of the invention need not necessarily achieve all of the advantages or possess all of the characteristics described above. Additionally, steps, elements, and features discussed herein in connection with one implementation can likewise be used in conjunction with other implementations. The contents of references, including reference texts, journal articles, patents, patent applications, etc., cited throughout the text are hereby incorporated by reference in their entirety for all purposes; and all appropriate combinations of implementations, features, characterizations, and methods from these references and the present disclosure may be included in implementations of this invention. Further still, the components and steps identified in the Background section are integral to this disclosure and can be used in conjunction with or substituted for components and steps described elsewhere in the disclosure within the scope of the invention.

What is claimed is:

1. An electrochemical destruction system, comprising:
an electrochemical reactor that defines a contained volume, wherein the electrochemical reactor includes at least one anode and at least one cathode in or extending into the contained volume of the electrochemical reactor, wherein the at least one anode and the at least one cathode are configured to break down per- and polyfluoroalkyl substances (PFAS) in wastewater in the contained volume via electro-oxidation reactions;
a pH adjustment device containing at least one of an acid or a base and configured to inject the acid or base into the contained volume of the electrochemical reactor or into a volume in fluid communication with the electrochemical reactor to facilitate controlling the pH of the wastewater; and
a defoamer in the contained volume of the electrochemical reactor or in a volume in fluid communication with the electrochemical reactor and configured to defoam foam generated in the wastewater from the electro-oxidation reactions.

2. The electrochemical destruction system of claim 1, further comprising a chemical dosing system containing (a) hydrogen peroxide (H₂O₂) and at least one of (b) ferrous ions (Fe²⁺) or ferric ions (Fe³⁺), wherein the chemical dosing system is configured to inject these compositions into the contained volume of the electrochemical reactor or into a volume in fluid communication with the electrochemical reactor.

3. The electrochemical destruction system of claim 1, further comprising a voltage source in electrical communication with the at least one anode and with the at least one cathode.

4. The electrochemical destruction system of claim 1, further comprising:
a storage tank that contains the wastewater;
a first conduit coupling the storage tank with the electrochemical reactor and configured to transfer the wastewater from the storage tank to the electrochemical reactor; and
a second conduit coupling the storage tank with the electrochemical reactor and configured to transfer the wastewater from the electrochemical reactor back to the storage tank.

5. The electrochemical destruction system of claim 4, wherein the pH adjustment device is configured to inject the acid or base into the storage tank.

6. The electrochemical destruction system of claim 4, wherein the defoamer is in the storage tank.

7. The electrochemical destruction system of claim 1, wherein the anode comprises boron-doped diamond.

8. The electrochemical destruction system of claim 1, wherein the anode comprises titanium suboxides.

9. The electrochemical destruction system of claim 1, wherein the cathode comprises at least one of titanium, stainless steel, mixed metal oxides or platinum, boron-doped diamond, or graphite.

10. The electrochemical destruction system of claim 1, wherein the defoamer is selected from a mechanical defoamer and an ultrasonicator.

11. The electrochemical destruction system of claim 1, further comprising a bath of the wastewater contained in the electrochemical reactor.

12. The electrochemical destruction system of claim 11, further comprising a foam layer formed of a liquid film surrounding gas bubbles atop the bath of the wastewater, wherein the liquid film of the foam layer contains a higher concentration of PFAS than does the bath of the wastewater.

13. The electrochemical destruction system of claim 1, further comprising a PFAS concentration system in fluid communication with the contained volume of the electrochemical reactor.

14. The electrochemical destruction system of claim 13, wherein the PFAS concentration system comprises at least one of a nanofiltration system, a reverse-osmosis system, an ultrafiltration system, a foam fractionation system, an ion-exchange system, or a granular-activated-carbon adsorption system.

15. The electrochemical destruction system of claim 1, wherein the wastewater includes a blend of PFAS and other organic chemicals.

16. A method for electrochemically destroying per- and polyfluoroalkyl substances (PFAS), comprising:
providing an electrochemical reactor containing a bath of wastewater that contains PFAS, wherein the electrochemical reactor includes at least one anode and at least one cathode immersed in the bath of wastewater;
adding an acid or a base to the wastewater to maintain a reaction pH in the electrochemical reactor at a targeted pH below 4.3;
in the electrochemical reactor, delivering an applied current and voltage to the immersed anode and cathode to electrochemically destroy at least some of the PFAS in the wastewater; and
defoaming foam produced in the electrochemical reactor.

17. The method of claim 16, wherein the wastewater further comprises additional organic carbon compounds.

18. The method of claim 17, wherein the additional organic carbon compounds include organic carbon compounds produced in an earlier industrial process and organic carbon compounds introduced into the wastewater in an upstream wastewater treatment process.

19. The method of claim 17, wherein at least 99% of the PFAS and the additional organic carbon compounds in the wastewater is destroyed in the electrochemical reactor.

20. The method of claim 17, further comprising:
adding hydrogen peroxide (H₂O₂) and at least one of ferrous ions (Fe²⁺) or ferric ions (Fe³⁺) to the wastewater; and
reducing the additional organic carbon compounds via a Fenton or electro-Fenton reaction utilizing hydroxyl radicals generated by the added hydrogen peroxide and the added Fe²⁺ and/or Fe³⁺ ions.

21. The method of claim 16, wherein the anode comprises boron-doped diamond or a titanium suboxide.

22. The method of claim 16, wherein the cathode comprises at least one of titanium, stainless steel, mixed metal oxides, and platinum, boron-doped diamond, or graphite.

23. The method of claim 16, wherein the foam comprises a liquid film surrounding gas bubbles atop the bath of the wastewater, wherein the liquid film of the foam contains a higher concentration of PFAS than does the bath of the wastewater.

24. The method of claim 16, further comprising concentrating PFAS in the wastewater from an upstream source and then delivering the wastewater with the concentrated PFAS to the electrochemical reactor.

25. The method of claim 24, wherein the PFAS is concentrated via a concentration system selected from at least one of nanofiltration, reverse osmosis, ultrafiltration, foam fractionation, ion exchange, or granular-activated-carbon adsorption.
